(19) United States
(12) Patent Application Publication
(10) Pub. No.: US 2026/0280685 A1
(43) Pub. Date: Sep. 17, 2026

(54) SATELLITE-BASED COMMUNICATION METHOD AND APPARATUS, COMPUTER-READABLE MEDIUM, AND ELECTRONIC DEVICE

(71) Applicant: Tencent Technology (Shenzhen) Company Limited, Shenzhen (CN)

(72) Inventors: Yixue LEI, Shenzhen (CN); Yuhang Jia, Shenzhen (CN)

(21) Appl. No.: 19/672,542

(22) Filed: May 8, 2026

Related U.S. Application Data
(63) Continuation of application No. PCT/CN2025/108580, filed on Jul. 15, 2025.

(30) Foreign Application Priority Data
Aug. 30, 2024 (CN) 202411219119.8

(51) Int. Cl. H04B 7/185

(52) U.S. Cl. CPC H04B 7/18515

(57) ABSTRACT

Embodiments of this application provide a satellite-based communication method performed by an electronic device in a spaceborne base station. The spaceborne base station is deployed on a first satellite and establishes a service link with a user equipment. The electronic device establishes a plurality of communication links between the spaceborne base station and core network elements. In response to a service request from the user equipment via the service link, the electronic device communicates with the core network elements by using a first communication link and when the first communication link is abnormal, communicates with the core network elements by using a second communication link. The technical solutions ensure uninterrupted data transmission between the spaceborne base station and the core network elements, thereby ensuring continuity of key data and services and facilitating construction of a more robust and efficient satellite communication network.

### CROSS-REFERENCE TO RELATED APPLICATIONS

This application is a continuation application of PCT Patent Application No. PCT/CN2025/108580, entitled “SATELLITE-BASED COMMUNICATION METHOD AND APPARATUS, COMPUTER-READABLE MEDIUM, AND ELECTRONIC DEVICE” filed on Jul. 15, 2025, which claims priority to Chinese Patent Application No. 202411219119.8, entitled "SATELLITE-BASED COMMUNICATION METHOD AND APPARATUS, COMPUTER-READABLE MEDIUM, AND ELECTRONIC DEVICE" filed with the China National Intellectual Property Administration on Aug. 30, 2024, all of which are incorporated herein by reference in their entirety.

### FIELD OF THE TECHNOLOGY

This application relates to the technical fields of computers and communications, and to a satellite-based communication method and apparatus, a computer-readable medium, and an electronic device.

### BACKGROUND OF THE DISCLOSURE

During research on wireless communication technologies, satellite communication is an important direction of future development of wireless communication technologies. Satellite communication refers to a technology in which wireless communication devices on the ground access a network by using a satellite, or refers to a technology in which wireless communication devices on the ground communicate with each other by using a satellite as a relay. Satellite communication features a large communication range and is not easily affected by terrestrial disasters. Satellite communication, as a supplement to access manners of mobile communication, effectively solves problems of small coverage and high construction cost of a mobile communication system.

A satellite communication system and a terrestrial mobile network, such as the 4th generation mobile communication technology (4G) network, the 5th generation mobile communication technology (5G) network, or a future evolved mobile communication technology (such as 6G) network, may be fused to form a globally seamless integrated communication network spanning sea, land, air, and space, to meet various service requirements of users all around. In an actual application scenario, a base station may be deployed on a satellite to obtain a spaceborne base station. Because the spaceborne base station moves with the satellite, a connection between the spaceborne base station and a core network element may be interrupted, thereby affecting service continuity.

### SUMMARY

Embodiments of this application provide a satellite-based communication method and apparatus, a computer-readable medium, and an electronic device, which can ensure uninterrupted data transmission between the spaceborne base station and the core network elements, thereby ensuring continuity of key data and services and facilitating construction of a more robust and efficient satellite communication network.

Other features and advantages of this application will become apparent through the following detailed description or partially learned through the practice of this application.

According to a first aspect, an embodiment of this application provides a satellite-based communication method performed by an electronic device in a spaceborne base station, the spaceborne base station being deployed on a first satellite and establishing a service link with a user equipment, and the communication method including: establishing a plurality of communication links between the spaceborne base station and core network elements; in response to a service request from the user equipment via the service link, communicating with the core network elements by using a first communication link in the plurality of communication links; and when the first communication link is abnormal, communicating with the core network elements by using a second communication link in the plurality of communication links.

According to a second aspect, an embodiment of this application provides an electronic device in a spaceborne base station deployed on a first satellite and having established a service link with a user equipment, the electronic device including one or more processors and a storage apparatus configured to store one or more computer programs, the one or more computer programs, when executed by the one or more processors, causing the electronic device to implement the satellite-based communication method according to the foregoing embodiment.

According to a third aspect, an embodiment of this application provides a non-transitory computer-readable medium, having a computer program stored therein, the computer program, when executed by a processor of an electronic device in a spaceborne base station deployed on a first satellite and having established a service link with a user equipment, causing the electronic device to implement the satellite-based communication method according to the foregoing embodiment.

In technical solutions provided in some embodiments of this application, the plurality of communication links are established between the spaceborne base station and the core network elements. The spaceborne base station can communicate with the core network elements by using the first communication link in the plurality of communication links. If it is detected that the first communication link is abnormal, the spaceborne base station can communicate with the core network elements by using the second communication link in the plurality of communication links. Thus, in the technical solutions of the embodiments of this application, the plurality of communication links between the spaceborne base station and the core network elements are established, so that when the first communication link is abnormal due to space environment interference, device faults, or another unpredictable factor, the spaceborne base station can quickly switch to the second communication link, to ensure uninterrupted data transmission between the spaceborne base station and the core network elements, thereby ensuring continuity of key data and services. This is especially important in application scenarios requiring high reliability, such as emergency communication, remote medical treatment, and ocean exploration, thereby facilitating construction of a more robust and efficient satellite communication network.

The foregoing general descriptions and the following detailed descriptions are exemplary and explanatory only and are not intended to limit this application.

### BRIEF DESCRIPTION OF THE DRAWINGS

FIG. 1 is a schematic diagram of an architecture of a fusion network of a satellite communication system and a terrestrial mobile network according to an embodiment of this application.

FIG. 2 is a schematic diagram of an architecture of a fusion network of a satellite communication system and a terrestrial mobile network according to an embodiment of this application.

FIG. 3 is a schematic diagram of an architecture of a fusion network of a satellite communication system and a terrestrial mobile network according to an embodiment of this application.

FIG. 4 is a schematic diagram of an architecture of a fusion network of a satellite communication system and a terrestrial mobile network according to an embodiment of this application.

FIG. 5 is a flowchart of a satellite-based communication method according to an embodiment of this application.

FIG. 6 is a schematic diagram of an architecture of a fusion network of a satellite communication system and a terrestrial mobile network according to an embodiment of this application.

FIG. 7 is a schematic diagram of an architecture of a fusion network of a satellite communication system and a terrestrial mobile network according to an embodiment of this application.

FIG. 8 is a schematic diagram of an architecture of a fusion network of a satellite communication system and a terrestrial mobile network according to an embodiment of this application.

FIG. 9 is a schematic diagram of an architecture of a fusion network of a satellite communication system and a terrestrial mobile network according to an embodiment of this application.

FIG. 10 is a schematic diagram of an architecture of a fusion network of a satellite communication system and a terrestrial mobile network according to an embodiment of this application.

FIG. 11 is a block diagram of a satellite-based communication apparatus according to an embodiment of this application.

FIG. 12 is a schematic structural diagram of a computer system adapted to implement an electronic device according to an embodiment of this application.

### DESCRIPTION OF EMBODIMENTS

Exemplary implementations are now described in a more comprehensive mode with reference to the accompanying drawings. However, exemplary implementations can be implemented in various forms and are not to be construed as limited to these examples. On the contrary, these implementations are provided to make this application more comprehensive and complete, and to fully convey the concepts of the exemplary embodiments to those skilled in the art.

In addition, the features, structures, or characteristics described in this application may be combined in one or more embodiments in any appropriate mode. The following description has many specific details, by which the embodiments of this application may be fully understood. However, those skilled in the art is to be aware that, technical solutions of this application may be implemented without using all detailed features in the embodiments, one or more details may be omitted, or other methods, elements, apparatuses, or operations may be used.

In the embodiment of this application, the term “module” or “unit” refers to a computer program with a preset function or a part of the computer program and works, together with other related parts, to implement a preset target, and may be completely or partially implemented by using software, hardware (for example, a processing circuit or a memory) or a combination thereof. Similarly, one processor (or a plurality of processor or memories) may be configured to implement one or more modules or units. In addition, each module or unit may be a part of an overall module or unit including a module or unit function.

The block diagrams shown in the accompanying drawings are merely functional entities and do not necessarily correspond to physically independent entities. To be specific, the functional entities may be implemented in a software form, or in one or more hardware modules or integrated circuits, or in different networks and/or processor apparatuses and/or microcontroller apparatuses.

The flowcharts shown in the accompanying drawings are merely exemplary descriptions, and do not necessarily include all content and operations/blocks, nor do they have to be executed in the described order. For example, some operations/blocks may further be broken down, but some operations/blocks may be merged or partially merged. Therefore, an actual execution order may change according to an actual situation.

"Plurality of" herein means two or more. "And/or" describes an association relationship for describing associated objects and represents that three relationships may exist. For example, A and/or B may represent the following three cases: only A exists, both A and B exist, and only B exists. The character "/" denotes an "or" relationship between the associated objects.

The technical solutions in the embodiments of this application involve fusion of a satellite communication system and a terrestrial mobile network. Such a fusion solution can form a globally seamless integrated communication network spanning sea, land, air, and space, to meet various service requirements of users all around. There are many fusion modes of the satellite communication system and the terrestrial mobile network. The following provides brief descriptions.

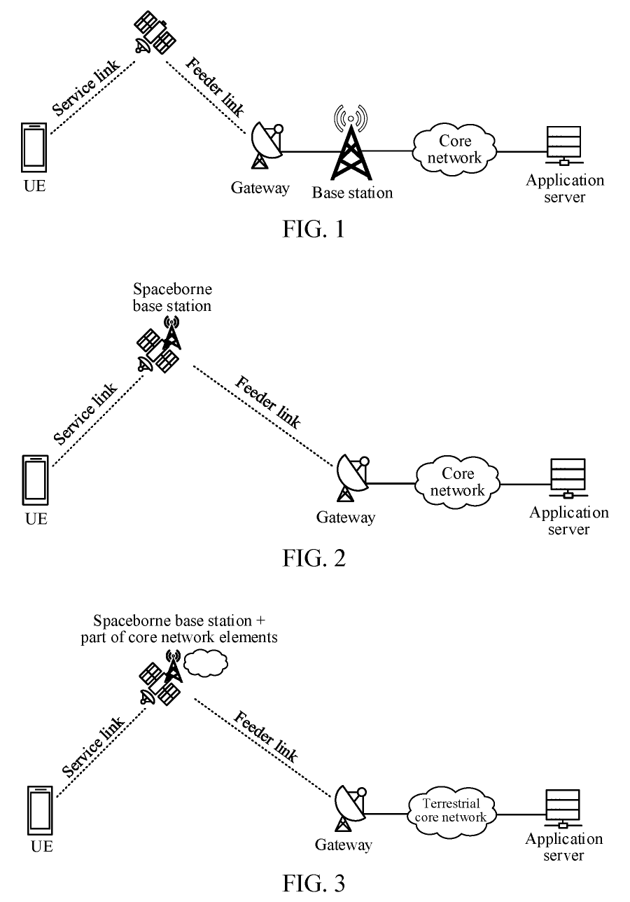

FIG. 1 is a schematic diagram of an architecture of a fusion network of a satellite communication system and a terrestrial mobile network according to an embodiment of this application. The fusion mode shown in FIG. 1 may be referred to as a transparent forwarding mode. All functions of a core network and base stations are deployed on the ground. A service link and a feeder link of a satellite, serving as bottom-layer link bearers of a Uu interface, provide support for communication between a base station and a user equipment (UE). The Uu interface is an interface between the base station and the UE, and is configured to transmit signaling and data. A gateway (which may collectively refer to a gateway deployed on the ground, that is, a terrestrial gateway or a gateway deployed on a satellite) communicates with the core network through the base station. The core network is in communication connection with the application server. In the transparent forwarding mode shown in FIG. 1, the satellite is only responsible for forwarding signals between the UE and the base station, and other related protocol processing of the mobile communication network is performed inside the mobile communication network.

The core network may be an evolved packet core (EPC), a 5G core network (5GC), or a core network of a future evolved mobile communication system. The base station may be an evolutional node B (eNB or eNodeB) in a 4G communication system, a gNB in a 5G communication system, or a base station device in a future mobile communication system. The gateway is a gateway deployed on the ground and configured to communicate with the satellite, which may be, for example, a non-terrestrial network gateway (NTN-GW) or another device implementing similar functions.

In the transparent forwarding mode shown in FIG. 1, because the base station and the core network device are deployed on the ground, there is a problem of a large delay. In addition, because this mode considers the satellite as a signal relay link only and it does not use the satellite to perform signal processing or conversion, communication transmission between satellites cannot be implemented. Therefore, this mode does not support an inter-satellite link (ISL), making it difficult to expand coverage on the surface of the Earth by using satellite constellations. In addition, the path between the satellite and the base station is long, resulting in a significant delay.

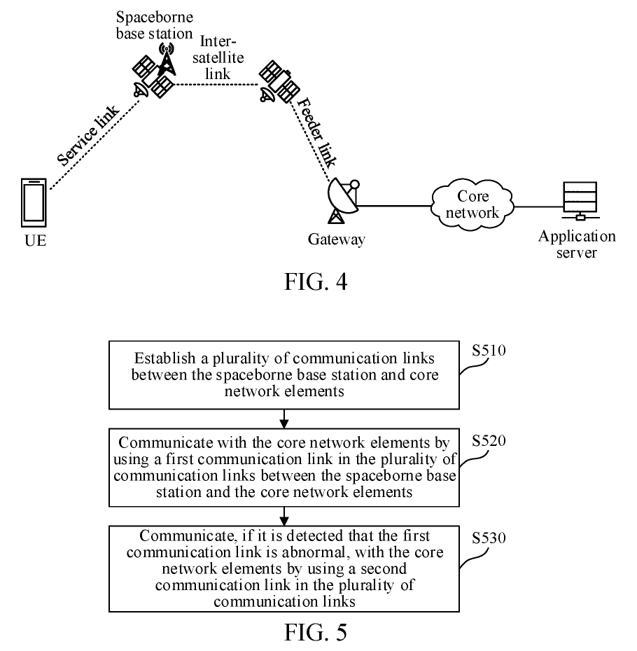

FIGS. 2 and 3 are respective schematic diagrams of an architecture of a fusion network of a satellite communication system and a terrestrial mobile network according to an embodiment of this application. The fusion mode shown in FIGS. 2 and 3 may be referred to as a regenerative mode, that is, a base station (as shown in FIG. 2), or a base station and part of core network elements (as shown in FIG. 3) are placed on a satellite. In this way, a link processing delay can be shortened, and satellite networking and the like can be implemented by using an ISL, as shown in FIG. 4, which is a schematic diagram of an architecture of a fusion network of a satellite communication system and a terrestrial mobile network according to an embodiment of this application.

Specifically, as shown in FIG. 2, the base station (which may be, for example, eNB or gNB) is deployed on the satellite and is referred to as a spaceborne base station. The core network (which may be, for example, EPC or 5GC) is deployed on the ground. The spaceborne base station may have a local data forwarding capability, that is, data transmission between different UEs may be implemented by using the spaceborne base station instead of using a terrestrial core network, thereby optimizing data routing, and saving transmission resources. Specifically, data transmitted by a UE is transmitted to the spaceborne base station by using a service link between the UE and the spaceborne base station, and then the spaceborne base station transmits, based on a service link between the spaceborne base station and another UE, the data to the other UE. In the embodiment shown in FIG. 2, the core network is in communication connection with an application server. When the UE needs to communicate with the application server, the UE needs to establish, based on a feeder link between the spaceborne base station and a gateway, a communication connection with the core network, to implement communication interaction with the application server based on the core network.

In the network architecture shown in FIG. 3, the base station (which may be, for example, eNB or gNB) is deployed on the satellite and is referred to as a spaceborne base station. In addition, part of core network (which may be, for example, EPC or 5GC) elements may also be deployed on the satellite. The spaceborne base station may have a local data forwarding capability, that is, data transmission between different UEs may be implemented by using the spaceborne base station instead of using a terrestrial core network, thereby optimizing data routing, and saving transmission resources. Specifically, data transmitted by a UE is transmitted to the spaceborne base station by using a service link between the UE and the spaceborne base station, and then the spaceborne base station transmits, based on a service link between the spaceborne base station and another UE, the data to the other UE. In addition, because part of the core network elements are deployed on the satellite, part of managements (such as access and mobility management, session management, and policy management) of the UE may also be implemented even if there is no interaction with the terrestrial core network. In addition, in the embodiment shown in FIG. 3, the terrestrial core network is in communication connection with the application server. When the UE needs to communicate with the application server, the UE needs to establish, based on a feeder link between the spaceborne base station and a gateway, a communication connection with the core network, to implement communication interaction with the application server based on the core network. In an embodiment, if an application server is also deployed on the satellite, the UE may also exchange data with the application server deployed on the satellite.

In the network architecture shown in FIG. 4, the base station (which may be, for example, eNB or gNB) is deployed on the satellite and is referred to as a spaceborne base station. The core network (which may be, for example, EPC or 5GC) is deployed on the ground, and certainly, part of core network elements may also be deployed on the satellite, as shown in FIG. 3. In the embodiment shown in FIG. 4, the core network is in communication connection with the application server, and the spaceborne base station is in communication connection with another satellite by using an ISL. When the UE needs to communicate with the application server, the UE needs to establish, based on an inter-satellite link between the spaceborne base station and another satellite and a feeder link between the other satellite and a gateway, a communication connection with the core network, to implement communication interaction with the application server based on the core network.

Although FIG. 4 shows only the ISL between two satellites, this embodiment of this application is not limited thereto. The UE may implement communication with the application server by using a plurality of ISLs between a plurality of satellites.

The UE in the above embodiment may be a smart phone, a tablet computer, a notebook computer, a desktop computer, a smart television, a smart home device, an in-vehicle terminal, an aircraft, or the like. The application server may be an independent physical server, may alternatively be a server cluster or a distributed system composed of a plurality of physical servers, or may alternatively be a cloud server that provides basic cloud computing services, such as cloud service, cloud database, cloud computing, cloud function, cloud storage, network service, cloud communication, middleware service, domain name service, security service, content delivery network (CDN), and big data and artificial intelligence platform.

With the network architectures shown in FIGS. 2-4, although the service link between the spaceborne base station and the UE may not change, the feeder link between the spaceborne base station and the gateway may change due to movement of the satellite. As a result, the connection between the spaceborne base station and the core network element (for example, the core network element deployed on the ground) may be interrupted, and the service continuity may be affected.

Based on this, the embodiments of this application provide a novel satellite-based communication solution. The plurality of communication links between the spaceborne base station and the core network elements may be established, so that when the first communication link is abnormal due to space environment interference, device faults, or another unpredictable factor, the spaceborne base station can quickly switch to the second communication link, to ensure uninterrupted data transmission between the spaceborne base station and the core network elements, thereby ensuring continuity of key data and services and facilitating construction of a more robust and efficient satellite communication network.

The following describes implementation details of the technical solutions of the embodiments of this application in detail.

FIG. 5 is a flowchart of a satellite-based communication method according to an embodiment of this application. The satellite-based communication method may be performed by an electronic device in a spaceborne base station. The spaceborne base station is deployed on a satellite (for example, referred to as a first satellite) and establishes a service link with a user equipment. Alternatively, the satellite-based communication method may also be performed by another device capable of implementing similar functions. As shown in FIG. 5, the satellite-based communication method includes at least operation S510 to operation S530, which will be described in detail as follows:

S510: Establish a plurality of communication links between the spaceborne base station and core network elements.

In this embodiment of this application, the spaceborne base station refers to a base station deployed on the satellite. In addition to implementing functions of a base station in the mobile communication system, the base station may move with the satellite. The spaceborne base station may be an eNB in a 4G system, a gNB in a 5G system, or a base station device in a future evolved mobile communication system.

In an embodiment, if the spaceborne base station is an eNB in a 4G system, the core network element establishing a communication connection with the spaceborne base station may be a mobility management entity (MME) in an EPC, or may be another network element. If the spaceborne base station is a gNB in a 5G system, the core network element establishing a communication connection with the spaceborne base station may be an access and mobility management function (AMF) in a 5GC, or may be another network element such as a user plane function (UPF).

In some embodiments, as shown in FIGS. 2-4, the spaceborne base station may establish a service link with a user equipment and establish a feeder link with a gateway, and the gateway is connected to a core network element in a core network. In an embodiment, the spaceborne base station may first establish a communication link (that is, a feeder link) with the gateway and then transmit a connection establishment request to the core network element by using the established communication link. If the spaceborne base station receives a connection establishment response returned by the core network element for the connection establishment request, it may be determined that the communication connection between the spaceborne base station and the core network element is successfully established.

In an embodiment, if the spaceborne base station is an eNB in a 4G system, the connection establishment request transmitted by the spaceborne base station may be an S1 establishment request. If the spaceborne base station is a gNB in a 5G system, the connection establishment request transmitted by the spaceborne base station may be an NG establishment request.

In an embodiment, the connection establishment request transmitted by the spaceborne base station to the core network element may include at least one of the following information: information about the service link between the spaceborne base station and the user equipment, information about the communication link between the spaceborne base station and the gateway, position information of the spaceborne base station, ephemeris information of the spaceborne base station (the ephemeris information refers to a table of accurate positions or trajectory of the spaceborne base station as a function of time), and network address information of the spaceborne base station.

The gateway between the spaceborne base station and the core network element may be a gateway deployed on the ground (that is, a terrestrial gateway), may be a collective name of a gateway deployed on the satellite (that is, a spaceborne gateway) and a gateway deployed on the ground (that is, a terrestrial gateway), or may be another device that can implement connection between the spaceborne base station and the core network.

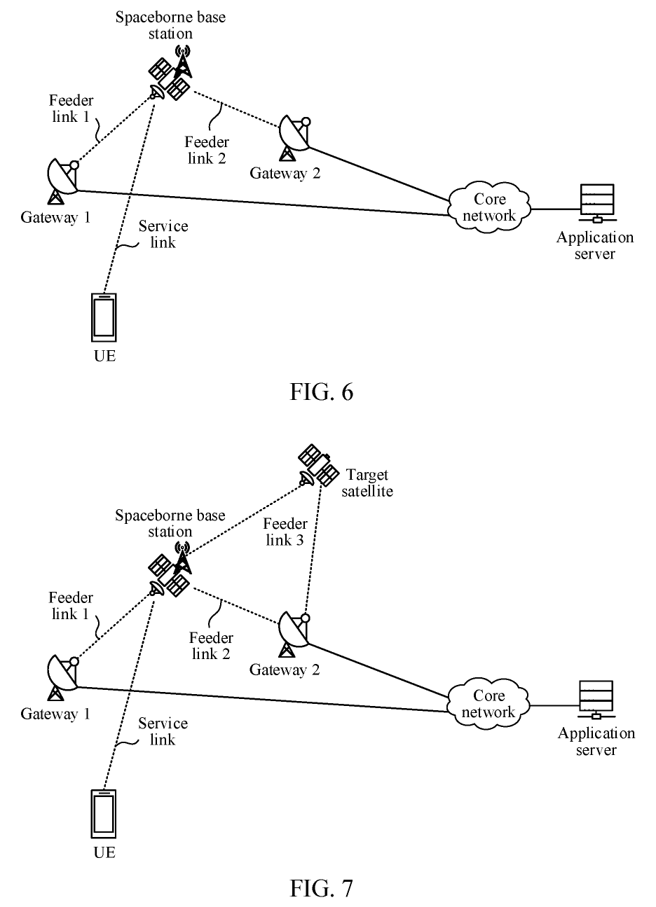

FIG. 6 is a schematic diagram of an architecture of a fusion network of a satellite communication system and a terrestrial mobile network according to an embodiment of this application. In some embodiments, a process of establishing a plurality of communication links between the spaceborne base station and the core network elements may include: establishing communication links between the spaceborne base station and a plurality of gateways. The plurality of gateways are connected to a core network element deployed on the ground. In an embodiment, a communication link between the spaceborne base station and at least one of the plurality of gateways may be established. The plurality of gateways are connected to the core network element deployed on the ground. In the example shown in FIG. 6, the spaceborne base station establishes a feeder link 1 with a gateway 1, and the gateway 1 is connected to the core network. In this way, the spaceborne base station may establish a communication link between the spaceborne base station and the core network element by using the feeder link 1 and the gateway 1. Moreover, the spaceborne base station establishes a feeder link 2 with a gateway 2, and the gateway 2 is connected to the core network. In this way, the spaceborne base station may establish a communication link between the spaceborne base station and the core network element by using the feeder link 2 and the gateway 2.

FIG. 7 is a schematic diagram of an architecture of a fusion network of a satellite communication system and a terrestrial mobile network according to an embodiment of this application. In some embodiments, a process of establishing a plurality of communication links between the spaceborne base station and core network elements may include: establishing an inter-satellite link between the spaceborne base station and another satellite (for example, referred to as a third satellite). The other satellite is connected to the core network element deployed on the ground. In the example shown in FIG. 7, the spaceborne base station establishes an inter-satellite link with a target satellite, and a communication link is established between the target satellite and a gateway 2. In this way, the spaceborne base station establishes a feeder link 3 between the spaceborne base station and the gateway 2 by using the target satellite, and further, the spaceborne base station may establish a communication link between the spaceborne base station and the core network element by using the feeder link 3 and the gateway 2.

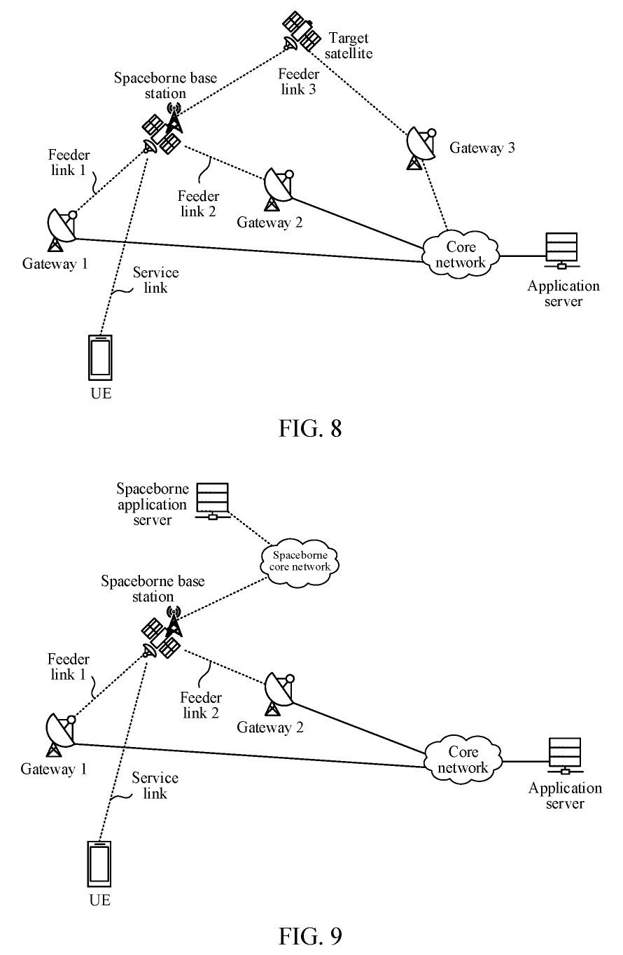

In the example shown in FIG. 7, the gateway 2 connected to the target satellite is also a gateway to which the spaceborne base station may be directly connected. Therefore, the feeder link 2 may also be directly established between the spaceborne base station and the gateway 2. However, in other embodiments of this application, the target satellite may also be connected to another gateway. FIG. 8 is a schematic diagram of an architecture of a fusion network of a satellite communication system and a terrestrial mobile network according to an embodiment of this application. In the example shown in FIG. 8, the target satellite may be connected to a gateway 3, and the gateway 3 is connected to the core network. In this way, the spaceborne base station establishes a feeder link 3 between the spaceborne base station and the gateway 3 by using the target satellite, and further, the spaceborne base station may establish a communication link between the spaceborne base station and the core network element by using the feeder link 3 and the gateway 3. In the example shown in FIG. 8, the spaceborne base station cannot be directly connected to the gateway 3 to which the target satellite is connected. Therefore, no feeder link can be directly established between the spaceborne base station and the gateway 3.

FIG. 9 is a schematic diagram of an architecture of a fusion network of a satellite communication system and a terrestrial mobile network according to an embodiment of this application. In some embodiments, a process of establishing a plurality of communication links between the spaceborne base station and core network elements may include: establishing a communication link between the spaceborne base station and a core network element deployed on the satellite (for example, the first satellite described above). The core network element deployed on the first satellite keeps data synchronization with the core network element deployed on the ground. In the example shown in FIG. 9, the spaceborne base station may be directly connected to a spaceborne core network, and the spaceborne core network may be connected to a spaceborne application server. The spaceborne core network may perform data synchronization with the core network deployed on the ground. Correspondingly, the spaceborne application server may also perform data synchronization with the application server deployed on the ground.

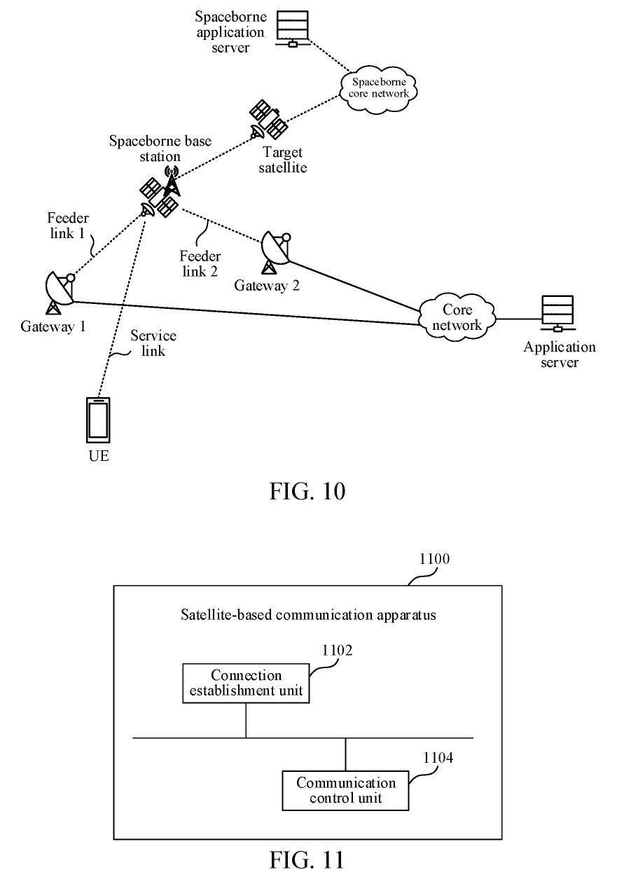

In the embodiment shown in FIG. 9, the spaceborne core network and the spaceborne base station may be deployed on the same satellite, that is, deployed on the first satellite described above. In other embodiments of this application, the spaceborne core network and the spaceborne base station may alternatively be deployed on different satellites. FIG. 10 is a schematic diagram of an architecture of a fusion network of a satellite communication system and a terrestrial mobile network according to an embodiment of this application. In the example shown in FIG. 10, the spaceborne base station (deployed on the first satellite) establishes an inter-satellite link with a target satellite (for example, referred to as a second satellite), and the spaceborne core network and the spaceborne application server are deployed on the target satellite. In this way, the spaceborne base station may establish a communication link between the spaceborne base station and the core network element deployed on the target satellite. In an embodiment, the spaceborne core network may alternatively be deployed on another satellite. In this way, the spaceborne base station may establish, by using the target satellite, a communication link with a core network element deployed on the other satellite. In addition, the spaceborne core network and the spaceborne application server may be deployed on the same satellite or on different satellites.

The target satellite in the foregoing embodiment may be a low earth orbit (LEO) satellite, a geostationary satellite orbit (GSO) satellite, a non-geostationary orbit (NGSO) satellite, or another type of satellite.

During specific implementation of this embodiment of this application, the plurality of communication links established between the spaceborne base station and the core network elements may include one type of communication links in the foregoing embodiments (that is, a plurality of communication links of one type are established), or may include two or more types of communication links in the foregoing embodiments, and one or more communication links of the same type may be established.

In some embodiments, when the plurality of communication links between the spaceborne base station and the core network elements are established, the plurality of communication links between the spaceborne base station and the core network elements may be established according to preconfigured ephemeris information. For example, a table of accurate positions or trajectory of the spaceborne base station as a function of time may be determined according to the preconfigured ephemeris information, then gateways, satellites, and the like to which a connection can be established are determined according to the position to which the spaceborne base station moves, and further, the plurality of communication links between the spaceborne base station and the core network elements may be established based on the determined gateways, satellites, and the like.

In some embodiments, when the plurality of communication links between the spaceborne base station and the core network elements are established, the plurality of communication links between the spaceborne base station and the core network elements may be established according to a communication status between the spaceborne base station and the core network elements. For example, according to interruption probabilities of candidate communication links between the spaceborne base station and the core network elements, communication links of which the interruption probability is less than or equal to a set probability threshold may be selected and established. Alternatively, according to device loads (for example, loads of gateways or busyness of inter-satellite links) on the candidate communication links between the spaceborne base station and the core network elements, communication links of which the load is less than or equal to a set load threshold may be selected and established.

In some embodiments, a process of establishing a plurality of communication links between the spaceborne base station and the core network elements may include: first, establishing the first communication link between the spaceborne base station and the core network elements, and establishing, if it is predicted that the first communication link is about to be abnormal (for example, it is determined that the first communication link is about to be interrupted according to the ephemeris information, or it is predicted that the communication quality is about to get worse), the second communication link (that is, a communication link other than the first communication link) between the spaceborne base station and the core network elements. In other words, the plurality of communication links between the spaceborne base station and the core network elements may not be established at the same time. In other embodiments of this application, the plurality of communication links between the spaceborne base station and the core network elements may alternatively be established when the spaceborne base station needs to establish a communication connection with the core network elements.

In some embodiments, because the plurality of communication links between the spaceborne base station and the core network elements are established, a control plane identifier and a user plane transmission tunnel identifier may be respectively allocated to the plurality of communication links, and then the control plane identifier and the user plane transmission tunnel identifier of the same communication link are correspondingly stored. For example, a control plane identifier and a user plane transmission tunnel identifier of the same communication link are stored as an identifier pair, or for the control plane identifier and the user plane transmission tunnel identifier of the same communication link, a one-to-one correspondence is established and stored. In this way, it is convenient to maintain a user plane interface and a control plane interface of each communication link.

Still referring to FIG. 5, S520: Communicate with the core network elements by using a first communication link in the plurality of communication links between the spaceborne base station and the core network elements.

In some embodiments, the first communication link may be any communication link in the plurality of communication links established between the spaceborne base station and the core network elements, or may be a communication link selected according to the communication quality and having better communication quality (for example, the best communication quality), or may be a communication link selected according to the transmission performance and having better transmission performance (for example, the best transmission performance), or may be a communication link selected in another manner. In an embodiment, the user equipment may communicate, based on the first communication link, with an application server connected to the core network element, to implement transmission of service data.

In some embodiments, because the plurality of communication links are established between the spaceborne base station and the core network elements, if the spaceborne base station can communicate with an application server by using all the plurality of communication links, user plane data between the user equipment and the application server may be jointly transmitted by using the plurality of communication links. In this way, throughput, reliability, and efficiency of data transmission can be improved by using the plurality of communication links.

In some embodiments, although the plurality of communication links are established between the spaceborne base station and the core network elements, control plane signaling between the spaceborne base station and the core network elements may be transmitted by using only one of the plurality of communication links. This can ensure that the control plane signaling is transmitted in a single transmission link, thereby facilitating management and maintenance.

S530: Communicate, if it is detected that the first communication link is abnormal, with the core network elements by using a second communication link in the plurality of communication links.

In some embodiments, if the first communication link is interrupted, it can be determined that the first communication link is abnormal, or if the communication quality of the first communication link decreases (for example, the signal-to-noise ratio is less than a certain threshold, the bit error rate is higher than a certain threshold, the bandwidth is lower than a certain threshold, or the delay is higher than a certain threshold), it can be determined that the first communication link is abnormal.

In some embodiments, the second communication link may be selected from the plurality of communication links by using at least one of the following factors: connectivity between the communication link and the core network element, connectivity between the communication link and the application server, transmission performance of the communication link, and a position of the core network element connected to the communication link. The position of the core network element includes being on the ground or being on the satellite.

In an embodiment, the transmission performance of the communication link may include, for example, bandwidth, delay, signal power, noise power, bit error rate, signal-to-noise ratio, throughput, data transmission rate, frequency utilization, protocol efficiency, and communication efficiency. The bandwidth refers to a range of frequencies through which a signal can pass. A larger bandwidth indicates a larger volume of data that can be transmitted. The delay refers to the time required for information to pass from a transmitter to a receiver, and includes propagation delay, processing delay, queuing delay, transmission delay, and the like. A shorter delay indicates a higher transmission speed and better user experience. The signal power is related to a communication distance, and indicates transmission strength of a signal. A higher signal power usually indicates a longer transmission distance or a stronger anti-interference capability of the signal. The noise power refers to an average noise level on a communication line. A lower noise power indicates a cleaner communication environment and less interference with signal transmission. The bit error rate (BER) refers to a ratio of incorrectly transmitted bits to the total number of transmitted bits. A lower bit error rate indicates a higher accuracy of transmission. The signal-to-noise ratio (SNR) refers to a ratio of signal to noise power, and indicates strength and clarity of a signal. A higher signal-to-noise ratio indicates a clearer signal and a better transmission effect. The throughput refers to the number of successfully transmitted bits per unit time. A higher throughput indicates a stronger data processing capability of a system. The data transmission rate may include a bit rate and a baud rate. The bit rate refers to a binary number of data transmitted in a communication system per unit time. A higher bit rate indicates a higher data transmission speed. The baud rate refers to the number of signal waveform changes transmitted in a communication system per unit time, and is also referred to as a modulation rate. The frequency utilization refers to a transmission speed in a unit frequency band, and reflects utilization efficiency of spectrum resources. The protocol efficiency refers to a ratio of the number of valid data bits in a transmitted data packet to the length of the entire data packet. A higher protocol efficiency indicates a higher data transmission efficiency. The communication efficiency refers to a ratio of the data frame transmission time to the total time required for transmitting a packet.

In some embodiments, if the first communication link includes a communication link between the spaceborne base station and a first core network element, the second communication link includes a communication link between the spaceborne base station and a second core network element, one of the first core network element and the second core network element is deployed on the ground, and the other is deployed on the satellite, then, after the spaceborne base station switches to communication with the core network element by using the second communication link in the plurality of communication links, the spaceborne base station may resume, between the user equipment and the second core network element, a protocol data unit (PDU) session between the user equipment and the first core network element.

In an embodiment, the spaceborne base station may coordinate with the second core network element such that the user equipment seamlessly switches to communication by using the second communication link. Alternatively, after switching to communication with the core network element by using the second communication link in the plurality of communication links, the spaceborne base station may receive a PDU session re-establishment request transmitted by the user equipment, and then transmit the PDU session re-establishment request to the second core network element such that the second core network element resumes, based on network information context synchronized from the first core network element, the PDU session corresponding to the user equipment. In this embodiment, the first core network element and the second core network element may periodically perform data synchronization. In this way, after the spaceborne base station switches to communication with the core network element (namely, the second core network element) deployed on the satellite by using the second communication link, the core network element deployed on the satellite may re-establish, based on the stored network information context, the PDU session.

In other embodiments of this application, after switching to communication with the core network element by using the second communication link in the plurality of communication links, the spaceborne base station may alternatively receive a PDU session establishment request transmitted by the user equipment, and then transmit the PDU session establishment request to the second core network element, to establish a PDU session between the user equipment and the second core network element. The technical solution of this embodiment may be applied to a scenario in which the core network element (namely, the second core network element) deployed on the satellite has not synchronized the context information of the PDU session of the user equipment before the spaceborne base station switches the communication link, or even if the context information of the previous PDU session has been synchronized, the PDU session may also be re-established.

In conclusion, the technical solution of this embodiment of this application is mainly as follows: The plurality of communication links between the spaceborne base station and the core network elements may be established, so that when one of the plurality of communication links is abnormal due to space environment interference, device faults, or another unpredictable factor, the spaceborne base station can quickly switch to another communication link, to ensure uninterrupted data transmission between the spaceborne base station and the core network elements. The plurality of communication links established between the spaceborne base station and the core network elements may include one type of communication links shown in FIGS. 6-10 (that is, a plurality of communication links of one type are established), or may include two or more types of communication links shown in FIGS. 6-10, and one or more communication links of the same type may be established.

In existing 4G and 5G network solutions, between the base station and the core network there is only one control plane link, and there may be a plurality of user plane links. For example, in a 4G system, there is only one non-access stratum (NAS) connection between the UE and the MME, which needs to be carried by using a unique S1-C interface. The S1-C interface is established between an eNB and the MME. In a 5G system, the NAS connection between the UE and the AMF is carried by an N2 interface. The following describes the technical solution of this embodiment of this application in an example of a 5G system.

To implement multiple paths (that is, a plurality of communication links) between the base station and the core networks, in an embodiment of this application, there may be more than one control plane connection and more than one user plane connection between the gNB and the AMF. When the N2 interface is established, the gNB and the AMF may establish a primary interface and a backup interface (or may also be referred to as a standby interface). There may be only one primary interface. When the primary interface is in a normal running state, control plane signaling transmission may not be performed on the backup interface.

In an embodiment, if both a primary path established by using the primary interface and a backup path (or referred to as a standby path, a secondary path, or the like) established by using the backup interface may be connected to the same data network (DN) and application server, user plane data transmission may be performed on both the primary path and the backup path, so as to improve throughput or reliability of user plane data transmission by using the multiple paths.

In an embodiment, when the connection between the gNB and the AMF is established by using the N2 interface and the connection between the gNB and the UPF is established by using the N3 interface, a control plane ID and a user plane tunnel endpoint identifier may be respectively allocated to the multiple paths. The identifiers may form a control plane-user plane identifier pair, to facilitate maintenance on the port in the primary path or the backup path.

In some embodiments, the spaceborne base station or the core network element may perform multi-path selection and configuration based on factors. For example, configuration of the backup path may be pre-generated according to the ephemeris information and statically configured to the spaceborne base station, or may be dynamically configured according to a dynamic status of the network. Static configuration is applicable to a scenario in which a satellite link providing a backup path may be accurately calculated according to the ephemeris information, and the static configuration may be used as a basis for configuration. Dynamic configuration is allowed to be performed according to a status of the network, such as the probability of connection interruption which may occur or dynamic load of the network. For example, if one ISL is selected by a plurality of spaceborne base stations as a backup link, the potential load of the ISL is large, and therefore, dynamic reconfiguration may be needed.

In some embodiments, dynamic selection of a backup path needs to be considered for both the spaceborne base station and the terrestrial core network. Principles for selecting a backup path include, but are not limited to: accessible gateways on the backup path; connectable DNs on the backup path; transmission performance of the backup path, such as bandwidth, delay, and transmission cost; and the position of the core network connected by the backup path, such as spaceborne or terrestrial.

In some embodiments, the core network element and the application server may implement a mirror mechanism, to support relocation of the application layer or quick resumption of the PDU session. Specifically, if there is no backup link having a suitable gateway connected to the terrestrial core network or the spaceborne core network, the connection between the UE and the server may be transferred from the satellite to the ground, or transferred from the ground to the satellite. In this scenario, for some key services or applications, the core network element and the application server may perform dynamic mirroring, so that after the communication link between the spaceborne base station and the core network element is disconnected, the PDU session, and the application data transmission between a terminal device and the application server can be resumed by using the backup path. For example, in a process in which the terminal device transmits data to the terrestrial core network and the application server after the core network, that is, before an interruption occurs, part of core network context related to the UE and context of the application server may be periodically mirrored to the core network element and the application server that are deployed on the satellite. In this way, after the spaceborne base station switches to connection to the core network element deployed on the satellite, the core network element deployed on the satellite may resume, based on the context information obtained by mirroring, the PDU session with the user equipment.

Specifically, the terminal device may transmit a PDU session re-establishment request to the new core network element (in a case of switching from the terrestrial core network element to the spaceborne core network element, the new core network element is the spaceborne core network element). If the new core network element has corresponding context (that is, there is an effective image), the request may be accepted, and the PDU session may be resumed quickly.

In an embodiment, if the new core network element has no corresponding context (there is no valid mirror), the new core network element may instruct the terminal device to re-initiate a PDU session establishment request. In this case, it takes a certain time to resume services between the terminal device and the application server, and the time is to be within a certain performance requirement range, to minimize impact on the service interruption. For example, the core network element and the application server to which the UE are newly connected may support a resume function on a terminal side in terms of protocol logic and application layer logic.

In the technical solutions of the foregoing embodiments of this application, the plurality of communication links between the spaceborne base station and the core network elements are established, so that when the communication link is abnormal, the spaceborne base station can quickly switch to another communication link, to ensure uninterrupted data transmission between the spaceborne base station and the core network elements, thereby ensuring continuity of key data and services. This is especially important in application scenarios requiring high reliability, such as emergency communication, remote medical treatment, and ocean exploration, thereby facilitating construction of a more robust and efficient satellite communication network and further meeting requirements for communication robustness in different scenarios. The technical solutions in the embodiments of this application are applicable not only to the 4G system and the 5G system, but also to the future evolved mobile communication system.

FIG. 11 is a block diagram of a satellite-based communication apparatus according to an embodiment of this application. The satellite-based communication apparatus may be applied to a spaceborne base station. The spaceborne base station is deployed on a first satellite and establishes a service link with a user equipment. Alternatively, the spaceborne base station may also be applied to another device capable of implementing similar functions.

Referring to FIG. 11, a satellite-based communication apparatus 1100 according to an embodiment of this application includes a connection establishment unit 1102 and a communication control unit 1104.

The connection establishment unit 1102 is configured to establish a plurality of communication links between the spaceborne base station and core network elements. The communication control unit 1104 is configured to communicate with the core network elements by using a first communication link in the plurality of communication links, and communicate, if it is detected that the first communication link is abnormal, with the core network elements by using a second communication link in the plurality of communication links.

In some embodiments of this application, based on the foregoing solution, the connection establishment unit 1102 is configured to establish the plurality of communication links between the spaceborne base station and the core network elements in one or more of the following manners:

establishing communication links between the spaceborne base station and a plurality of gateways, the plurality of gateways being connected to a core network element deployed on ground;

establishing a communication link between the spaceborne base station and a core network element deployed on the first satellite, the core network element deployed on the first satellite keeping data synchronization with the core network element deployed on the ground;

establishing a communication link between the spaceborne base station and a core network element deployed on a second satellite, the core network element deployed on the second satellite keeping data synchronization with the core network element deployed on the ground; and

establishing an inter-satellite link between the spaceborne base station and a third satellite, the third satellite being connected to the core network element deployed on the ground.

In some embodiments of this application, based on the foregoing solution, the communication control unit 1104 is further configured to: jointly transmit, if communication with an application server is available by using each of the plurality of communication links, user plane data between the user equipment and the application server by using the plurality of communication links.

In some embodiments of this application, based on the foregoing solution, the communication control unit 1104 is further configured to: transmit control plane signaling between the spaceborne base station and the core network elements by using one of the plurality of communication links.

In some embodiments of this application, based on the foregoing solution, the connection establishment unit 1102 is configured to establish, according to preconfigured ephemeris information, the plurality of communication links between the spaceborne base station and the core network elements; or

establish, according to a communication status between the spaceborne base station and the core network elements, the plurality of communication links between the spaceborne base station and the core network elements.

In some embodiments of this application, based on the foregoing solution, the establishing, according to a communication status between the spaceborne base station and the core network elements, the plurality of communication links between the spaceborne base station and the core network elements includes at least one of the following:

selecting and establishing, according to interruption probabilities of candidate communication links between the spaceborne base station and the core network elements, communication links of which the interruption probability is less than or equal to a set probability threshold; and

selecting and establishing, according to device loads on the candidate communication links between the spaceborne base station and the core network elements, communication links of which the load is less than or equal to a set load threshold.

In some embodiments of this application, based on the foregoing solution, the communication control unit 1104 is configured to select the second communication link from the plurality of communication links by using at least one of the following factors: connectivity between the communication link and the core network element, connectivity between the communication link and the application server, transmission performance of the communication link, and a position of the core network element connected to the communication link. The position of the core network element includes being on the ground or being on the satellite.

In some embodiments of this application, based on the foregoing solution, the first communication link includes a communication link between the spaceborne base station and a first core network element, and the second communication link includes a communication link between the spaceborne base station and a second core network element. One of the first core network element and the second core network element is deployed on the ground, and the other is deployed on the satellite.

The communication control unit 1104 is configured to: resume, between the user equipment and the second core network element, a protocol data unit (PDU) session between the user equipment and the first core network element after switching to communication with the core network elements by using the second communication link.

In some embodiments of this application, based on the foregoing solution, a process of the communication control unit 1104 resuming, between the user equipment and the second core network element, the protocol data unit (PDU) session between the user equipment and the first core network element includes: receiving a PDU session re-establishment request transmitted by the user equipment, and transmitting the PDU session re-establishment request to the second core network element such that the second core network element resumes, based on network information context synchronized from the first core network element, the PDU session corresponding to the user equipment.

In some embodiments of this application, based on the foregoing solution, the first core network element and the second core network element periodically perform data synchronization.

In some embodiments of this application, based on the foregoing solution, the first communication link includes a communication link between the spaceborne base station and a first core network element, and the second communication link includes a communication link between the spaceborne base station and a second core network element. One of the first core network element and the second core network element is deployed on the ground, and the other is deployed on the satellite.

The communication control unit 1104 is configured to: receive a PDU session establishment request transmitted by the user equipment after switching to communication with the core network elements by using the second communication link; and transmit the PDU session establishment request to the second core network element, to establish a PDU session between the user equipment and the second core network element.

In some embodiments of this application, based on the foregoing solution, the connection establishment unit 1102 is configured to: establish the first communication link between the spaceborne base station and the core network elements, and establish, if it is predicted that the first communication link is about to be abnormal, the second communication link between the spaceborne base station and the core network elements; or

establish, when the spaceborne base station needs to establish communication with the core network elements, the plurality of communication links between the spaceborne base station and the core network elements.

In some embodiments of this application, based on the foregoing solution, the communication control unit 1104 is further configured to: respectively allocate a control plane identifier and a user plane transmission tunnel identifier to the plurality of communication links, and correspondingly store the control plane identifier and the user plane transmission tunnel identifier of the same communication link.

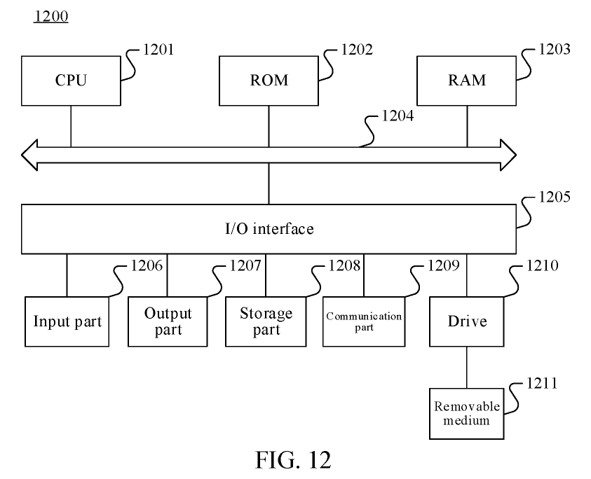

FIG. 12 is a schematic structural diagram of a computer system adapted to implement an electronic device according to an embodiment of this application. The electronic device may be the spaceborne base station in the foregoing embodiments.

The computer system 1200 of the electronic device shown in FIG. 12 is merely an example, and does not constitute any limitation on the function and scope of use of the embodiments of this application.

As shown in FIG. 12, the computer system 1200 may include a central processing unit (CPU) 1201, which may perform various suitable actions and processing based on a program stored in a read-only memory (ROM) 1202 or a program loaded from a storage part 1208 into a random access memory (RAM) 1203, for example, perform the method described in the foregoing embodiments. The RAM 1203 further has various programs and data required for system operation stored therein. The CPU 1201, the ROM 1202, and the RAM 1203 are connected to each other through a bus 1204. An input/output (I/O) interface 1205 is also connected to the bus 1204.

The following components may be connected to the I/O interface 1205: an input part 1206 including a keyboard, a mouse, or the like; an output part 1207 including a cathode ray tube (CRT), a liquid crystal display (LCD), a speaker, or the like; a storage part 1208 including a hard disk, or the like; and a communication part 1209 including a network interface card such as a local area network (LAN) card or a modem. The communication part 1209 performs communication processing by using a network such as the Internet. A drive 1210 is also connected to the I/O interface 1205 as required. A removable medium 1211, such as a magnetic disk, an optical disc, a magneto-optical disk, or a semiconductor memory, is installed on the drive 1210 as required, so that a computer program read from the removable medium is installed into the storage part 1208 as required.

Particularly, according to an embodiment of this application, the processes described in the above by referring to the flowcharts may be implemented as computer software programs. For example, an embodiment of this application provides a computer program product, which includes a computer program carried on a non-transitory computer-readable medium. The computer program is configured for performing the method shown in the flowchart. In such an embodiment, the computer program may be downloaded and installed from a network through the communication part 1209, and/or installed from the removable medium 1211. When the computer program is executed by the CPU 1201, the various functions defined in the system of this application are executed.

The computer-readable medium shown in the embodiments of this application may be a computer-readable signal medium or a computer-readable storage medium or any combination thereof. The computer-readable storage medium may be, for example, but is not limited to, an electric, magnetic, optical, electromagnetic, infrared, semi-conductive system, apparatus, or device, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM), a flash memory, an optical fiber, a compact disk read-only memory (CD-ROM), an optical storage device, a magnetic storage device, or any appropriate combination thereof. In this application, the computer-readable storage medium may be any tangible medium containing or storing a computer program, and the computer program may be used by or used in combination with an instruction execution system, apparatus, or device. In this application, the computer-readable signal medium may include a data signal transmitted in a baseband or as part of a carrier, and stores a computer-readable computer program. A data signal propagated in such a way may assume a plurality of forms, including, but not limited to, an electromagnetic signal, an optical signal, or any appropriate combination thereof. The computer-readable signal medium may further be any computer-readable medium other than the computer-readable storage medium. The computer-readable medium may send, propagate, or transmit a program used by or in combination with the instruction execution system, apparatus, or device. The computer program included in the computer-readable medium may be transmitted by using any suitable medium, including but not limited to: a wireless medium, a wire, or the like, or any suitable combination thereof.

The flowcharts and block diagrams in the accompanying drawings illustrate available system architectures, functions, and operations that may be implemented by a system, a method, and a computer program product according to various embodiments of this application. Each block in a flowchart or a block diagram may represent a module, a program segment, or a part of code. The module, the program segment, or the part of code includes one or more executable instructions used for implementing specified logic functions. In some alternative implementations, functions annotated in the blocks may also be executed in an order different from those annotated in the accompanying drawings. For example, two blocks shown in succession may be performed in parallel, and sometimes the two blocks may be performed in a reverse order. This depends on the functions involved. Each block of the block diagrams or the flowcharts and combinations of blocks in the block diagrams or the flowcharts may be implemented by a dedicated hardware-based system that performs specified functions or operations, or may be implemented by a combination of dedicated hardware and a computer program.

A related unit described in the embodiments of this application may be implemented in a software manner, or may be implemented in a hardware manner, and the unit described may also be set in a processor. Names of the units do not constitute a limitation on the units in a specific case.

According to another aspect, this application further provides a computer-readable medium. The computer-readable medium may be included in the electronic device described in the foregoing embodiments, or may exist alone and is not installed in the electronic device. The foregoing computer-readable medium carries one or more computer programs. The one or more computer programs, when executed by one electronic device, cause the electronic device to implement the method according to the foregoing embodiments.

Although a plurality of modules or units of a device configured to perform actions are mentioned in the foregoing detailed description, such division is not mandatory. According to the implementations of this application, the features and functions of two or more modules or units described above may be specifically implemented in one module or unit. On the contrary, the features and functions of one module or unit described above may further be divided to be specifically implemented by a plurality of modules or units.

Through the foregoing descriptions of the implementations, those skilled in the art may readily understand that the exemplary implementations described herein may be implemented by software, or may be implemented by combining software with necessary hardware. Therefore, the technical solutions in the implementations of this application may be implemented in the form of software product. The software product may be stored in a non-volatile storage medium (which may be a CD-ROM, a universal serial bus (USB) flash drive, a removable hard disk, or the like) or on a network, including several instructions to cause an electronic device to perform the method according to the implementations of this application. For example, the electronic device may be a spaceborne base station, and then the spaceborne base station may perform the satellite-based communication method shown in FIG. 5.

After considering the specification and practicing the implementations disclosed here, those skilled in the art may easily conceive of other implementations of this application. This application is intended to cover any variations, uses, or adaptive changes of this application. These variations, uses, or adaptive changes follow the general principles of this application and include common general knowledge or common technical means in the art, which are not disclosed in this application.

This application is not limited to the precise structures described above and shown in the accompanying drawings, and various modifications and changes can be made without departing from the scope of this application. The scope of this application is subject only to the appended claims.

What is claimed is:

1. A satellite-based communication method, performed by an electronic device in a spaceborne base station deployed on a first satellite and having established a service link with a user equipment, and the method comprising:
establishing a plurality of communication links between the spaceborne base station and core network elements;
in response to a service request from the user equipment via the service link, communicating with the core network elements by using a first communication link in the plurality of communication links; and
when the first communication link is abnormal, communicating with the core network elements by using a second communication link in the plurality of communication links.

2. The satellite-based communication method according to claim 1, wherein the establishing the plurality of communication links between the spaceborne base station and the core network elements comprises one or more of the following manners:
establishing communication links between the spaceborne base station and a plurality of gateways connected to a core network element deployed on ground;
establishing a communication link between the spaceborne base station and a core network element deployed on the first satellite, the core network element deployed on the first satellite keeping data synchronization with the core network element deployed on the ground;
establishing a communication link between the spaceborne base station and a core network element deployed on a second satellite, the core network element deployed on the second satellite keeping data synchronization with the core network element deployed on the ground; and
establishing an inter-satellite link between the spaceborne base station and a third satellite, the third satellite being connected to the core network element deployed on the ground.

3. The satellite-based communication method according to claim 1, further comprising:
jointly transmitting user plane data between the user equipment and an application server by using the plurality of communication links.

4. The satellite-based communication method according to claim 1, further comprising:
transmitting control plane signaling between the spaceborne base station and the core network elements by using one of the plurality of communication links.

5. The satellite-based communication method according to claim 1, wherein the establishing the plurality of communication links between the spaceborne base station and the core network elements comprises at least one of the following:
establishing, according to preconfigured ephemeris information, the plurality of communication links between the spaceborne base station and the core network elements; and
establishing, according to a communication status between the spaceborne base station and the core network elements, the plurality of communication links between the spaceborne base station and the core network elements.

6. The satellite-based communication method according to claim 5, wherein the establishing, according to a communication status between the spaceborne base station and the core network elements, the plurality of communication links between the spaceborne base station and the core network elements comprises at least one of the following:
selecting and establishing, according to interruption probabilities of candidate communication links between the spaceborne base station and the core network elements, communication links of which the interruption probability is less than or equal to a set probability threshold; and
selecting and establishing, according to device loads on the candidate communication links between the spaceborne base station and the core network elements, communication links of which the load is less than or equal to a set load threshold.

7. The satellite-based communication method according to claim 1, wherein the second communication link is selected from the plurality of communication links by using at least one of the following factors:
connectivity between the communication link and a core network element, connectivity between the communication link and an application server, transmission performance of the communication link, and a position of the core network element connected to the communication link, wherein the position of the core network element comprises being on the ground or being on the satellite.

8. The satellite-based communication method according to claim 1, wherein the first communication link comprises a communication link between the spaceborne base station and a first core network element, and the second communication link comprises a communication link between the spaceborne base station and a second core network element; one of the first core network element and the second core network element is deployed on the ground, and the other is deployed on the satellite; and the communication method further comprises:
resuming a protocol data unit (PDU) session between the user equipment and the first core network element after switching to communication with the core network elements by using the second communication link.

9. The satellite-based communication method according to claim 8, wherein the resuming the protocol data unit (PDU) session between the user equipment and the first core network element comprises:
receiving a PDU session re-establishment request transmitted by the user equipment, and transmitting the PDU session re-establishment request to the second core network element such that the second core network element resumes the PDU session corresponding to the user equipment based on network information context synchronized from the first core network element.

10. The satellite-based communication method according to claim 9, wherein the first core network element and the second core network element periodically perform data synchronization.

11. The satellite-based communication method according to claim 1, wherein the establishing the plurality of communication links between the spaceborne base station and core network elements comprises:
establishing the first communication link between the spaceborne base station and the core network elements, and when the first communication link is about to be abnormal, establishing the second communication link between the spaceborne base station and the core network elements.

12. The satellite-based communication method according to claim 1, further comprising:
respectively allocating a control plane identifier and a user plane transmission tunnel identifier to the plurality of communication links, and correspondingly storing the control plane identifier and the user plane transmission tunnel identifier of a same communication link.

13. An electronic device in a spaceborne base station deployed on a first satellite and having established a service link with a user equipment, the electronic device comprising:
one or more processors; and
a memory, configured to store one or more computer programs, the one or more computer programs, when executed by the one or more processors, causing the electronic device to implement a satellite-based communication method including:
establishing a plurality of communication links between the spaceborne base station and core network elements;
in response to a service request from the user equipment via the service link, communicating with the core network elements by using a first communication link in the plurality of communication links; and
when the first communication link is abnormal, communicating with the core network elements by using a second communication link in the plurality of communication links.

14. The electronic device according to claim 13, wherein the establishing the plurality of communication links between the spaceborne base station and the core network elements comprises one or more of the following manners:
establishing communication links between the spaceborne base station and a plurality of gateways connected to a core network element deployed on ground;
establishing a communication link between the spaceborne base station and a core network element deployed on the first satellite, the core network element deployed on the first satellite keeping data synchronization with the core network element deployed on the ground;
establishing a communication link between the spaceborne base station and a core network element deployed on a second satellite, the core network element deployed on the second satellite keeping data synchronization with the core network element deployed on the ground; and
establishing an inter-satellite link between the spaceborne base station and a third satellite, the third satellite being connected to the core network element deployed on the ground.

15. The electronic device according to claim 13, wherein the method further comprises:
jointly transmitting user plane data between the user equipment and an application server by using the plurality of communication links.

16. The electronic device according to claim 13, wherein the method further comprises:
transmitting control plane signaling between the spaceborne base station and the core network elements by using one of the plurality of communication links.

17. The electronic device according to claim 13, wherein the establishing the plurality of communication links between the spaceborne base station and the core network elements comprises at least one of the following:
establishing, according to preconfigured ephemeris information, the plurality of communication links between the spaceborne base station and the core network elements; and
establishing, according to a communication status between the spaceborne base station and the core network elements, the plurality of communication links between the spaceborne base station and the core network elements.

18. The electronic device according to claim 13, wherein the second communication link is selected from the plurality of communication links by using at least one of the following factors:
connectivity between the communication link and a core network element, connectivity between the communication link and an application server, transmission performance of the communication link, and a position of the core network element connected to the communication link, wherein the position of the core network element comprises being on the ground or being on the satellite.

19. The electronic device according to claim 13, wherein the first communication link comprises a communication link between the spaceborne base station and a first core network element, and the second communication link comprises a communication link between the spaceborne base station and a second core network element; one of the first core network element and the second core network element is deployed on the ground, and the other is deployed on the satellite; and the communication method further comprises:
resuming a protocol data unit (PDU) session between the user equipment and the first core network element after switching to communication with the core network elements by using the second communication link.

20. A non-transitory computer-readable medium, having a computer program stored therein, the computer program, when executed by a processor of an electronic device in a spaceborne base station deployed on a first satellite and having established a service link with a user equipment, causing the electronic device to implement a satellite-based communication method including:
establishing a plurality of communication links between the spaceborne base station and core network elements;
in response to a service request from the user equipment via the service link, communicating with the core network elements by using a first communication link in the plurality of communication links; and
when the first communication link is abnormal, communicating with the core network elements by using a second communication link in the plurality of communication links.
